(19) United States
(12) Patent Application Publication
(10) Pub. No.: US 2008/0266101 A1
(43) Pub. Date: Oct. 30, 2008

(54) SECURITY TAG SENSOR AND SECCURITY MEETHOD FOR CAPITAL ASSETS

(75) Inventors: Larry K. CANIPE, Boca Raton, FL (US); Steven V. LEONE, Lake Worth, FL (US); Reuel A. ELY, Plantation, FL (US)

Correspondence Address: Christopher & Weisberg, P.A., 200 East Las Olas Boulevard, Suite 2040, Fort Lauderdale, FL, 33301, US

(73) Assignee: SENSORMATIC ELECTRONICS CORPORATION, Boca Raton, FL (US)

(21) Appl. No.: 12/043,679

(22) Filed: Mar. 6, 2008

Related U.S. Application Data
(60) Provisional application No. 60/926,477, filed on Apr. 27, 2007.

(51) Int. Cl. G08B 13/22

(52) U.S. Cl. 340/572.3

(57) ABSTRACT

An adaptive security device includes a tag module and a processor module. The processor module contains a tag disable electronic circuit and a controller. The controller provides tag control commands to the tag disable electronic circuit. The tag disable electronic circuit selectively enables or disables the tag module based on the tag control command. In one embodiment, the tag module is an electronic article surveillance (“EAS”) tag module.

### CROSS-REFERENCE TO RELATED APPLICATION

This application is related to and claims priority to U.S. Provisional Patent Application Ser. No. 60/926,477, filed Apr. 27, 2007, entitled SECURITY TAG SENSOR AND SECURITY METHOD FOR CAPITAL ASSETS, the entirety of which is incorporated herein by reference.

### STATEMENT REGARDING FEDERALLY SPONSORED RESEARCH OR DEVELOPMENT

n/a

### FIELD OF THE INVENTION

The present invention relates to electronic article surveillance (“EAS”) systems and more particularly to an adoptive security tag for EAS and non-EAS devices.

### BACKGROUND OF THE INVENTION

Electronic article surveillance (“EAS”) systems are detection systems that allow the identification of a marker or tag within a given detection region. EAS systems have many uses, but most often they are used as security systems for preventing shoplifting in stores or removal of property in office buildings. EAS systems come in many different forms and make use of a number of different technologies.

A typical EAS system includes an electronic detection unit, tags and/or markers, and a detacher or deactivator. The detection units can, for example, be formed as pedestal units, buried under floors, mounted on walls, or hung from ceilings. The detection units are usually placed in high traffic areas, such as entrances and exits of stores or office buildings. The tags and/or markers have special characteristics and are specifically designed to be affixed to or embedded in merchandise or other objects sought to be protected. When an active tag passes through a tag detection zone, the EAS system sounds an alarm, a light is activated and/or some other suitable alert devices are activated to indicate the removal of the tag from the prescribed area. Another way to protect the asset is to lock the device in a base unit until authorized personnel can remove it. This is cumbersome and inefficient.

Capital assets used in radio frequency identification (“RFID”) and electronic article surveillance (“EAS”) systems such as mobile barcode scanners, RFID readers, EAS devices and other inventory and security devices often need to be protected from theft. One typical way to prevent theft of these devices is to tether the mobile device to a fixed object or surface such as a counter top or under-counter scanner, deactivator or pedestal unit. Such tethering of devices is a poor way to protect these devices because it greatly limits the mobility of the devices and makes operation difficult and frustrating.

One way to protect these devices without tethering them is to affix a non-deactivatible EAS hard tag to the device being protected (preferably in a concealed or internal location), so that if someone tries to leave the premises with the device, EAS detection units will alarm. One remaining problem is that sometimes the device being protected is itself an EAS device, in which case the EAS hard tag would not work as it would be detected by the EAS device itself. Another remaining problem is that sometimes the device is required to operate in or around other EAS security units, e.g., pedestals, and their corresponding detection/deactivation and/or interrogation zones. This usage proximate other EAS devices can trigger alarms because it will be detected by the other EAS devices.

Therefore, what is needed is an adaptive security tag and system for protecting capital assets from theft that can operate in EAS detection zones without causing false alarm, yet be detected by EAS exit systems.

### SUMMARY OF THE INVENTION

The present invention advantageously provides a method, adaptive security device and EAS sensor for protecting EAS and non-EAS capital assets from theft. The adaptive security device allows EAS security tag modules to be selectively activated and deactivated by a control signal.

In one embodiment of the present invention, an adaptive security device includes a tag module and a processor module containing a tag disable electronic circuit and a controller. The controller provides at least one control command to the tag disable circuit for selectively enabling and disabling the tag module. The tag module may be an electronic article surveillance (“EAS”) tag module.

In another embodiment, an adaptive EAS sensor for enabling and disabling an EAS tag includes a sensing element, a tag disable electronic circuit, and a controller adapted to receive signals from the sensing element. The controller provides at least one tag control command to the tag disable circuit based upon signals received from the sensing element. The tag disable electronic circuit, upon receiving the signal, is operable to selectively enable or disable the EAS tag based on the at least one tag control command.

In another embodiment, a method for protecting assets from theft includes receiving at least one tag control command that indicates the activation state of an adaptive security device and selectively enabling and disabling the adaptive security device based on the received tag control command.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein like designations refer to like elements, and wherein:

FIG. 1 is a block diagram of an EAS security device for use in an EAS system constructed in accordance with the principles of the present invention;

FIG. 2 is a schematic diagram of an exemplary disable electronic circuit of an EAS security device constructed in accordance with the principles of the present invention;

FIG. 3 is a schematic diagram of another exemplary disable electronic circuit of an EAS security device constructed in accordance with the principles of the present invention; and

FIG. 4 is a schematic diagram of another exemplary disable electronic circuit of an EAS security device constructed in accordance with the principles of the present invention.

### DETAILED DESCRIPTION OF THE INVENTION

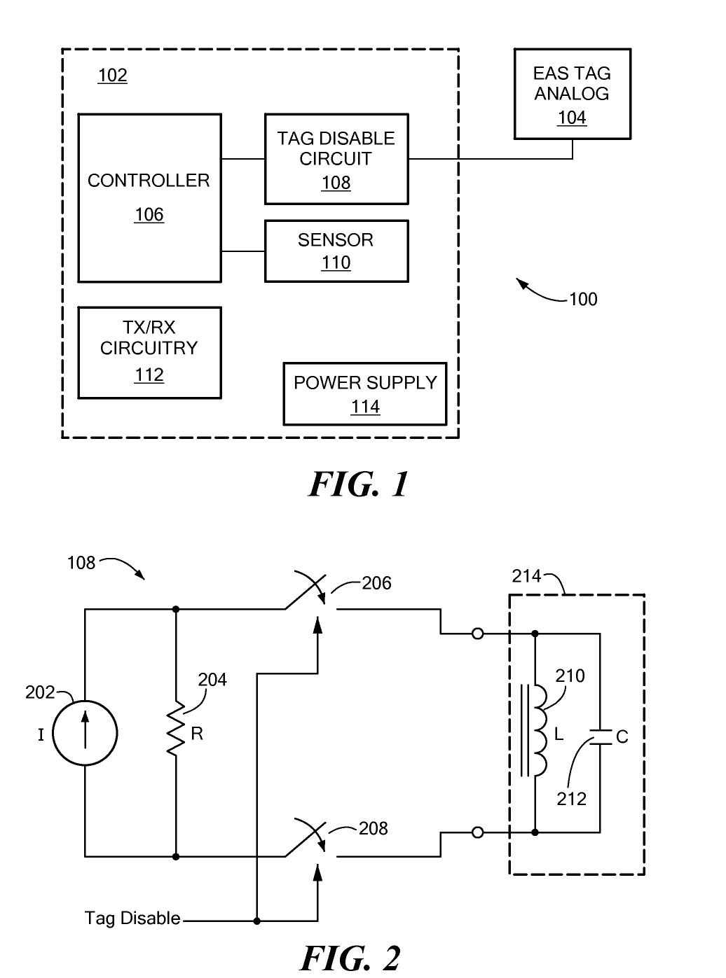

Referring now to the drawing figures in which like reference designators refer to like elements, there is shown in FIG. 1 a diagram of an exemplary device constructed in accordance with the principles of the present invention and designated generally as “100”. Adaptive security device 100 is affixable to an EAS or non-EAS device to be protected. Adaptive security device 100 includes a processor module 102 and an EAS tag analog module 104. The processor module 102 includes a controller 106 that controls the transmission and reception of signals, e.g., radio frequency, acousto-magnetic, electromagnetic, etc., between the device 100 and a security system such as an EAS system or an RFID system.

The processor module 102 also includes a tag disable electronic circuit 108. The tag disable electronic circuit 108 receives a transmit control signal, e.g., receive off (“RXOFF”), from the controller 106. In this embodiment, and for illustrative purposes only, when the RXOFF signal is a logical high, the tag disable electronic circuit 108 does not generate a disable signal and the analog module 104 remains active or enabled. On the other hand, when the RXOFF signal is a logical low, the tag disable electronic circuit 108 generates a disable signal that causes the analog module 104 to be disabled. The transmit control signal RXOFF is one example of a control command issued by controller 106. Other examples of potential disable events include but are not limited to proximity of the protected device to other EAS devices or systems such as an EAS tag detector or a counter top deactivator.

The processor module 102 can optionally include a sensor 110, transmit/receive circuitry 112 and a power supply 114. The optional sensor 110 can be any of various sensor devices including but not limited to proximity sensors that can detect or measure the proximity of the device 100 to an EAS unit such as, for example, a pedestal located at the exit of a commercial store. The optional sensor 110 can be used in addition to any sensor functionality supplied by the tag analog module 104. For example, as the tag analog module 104 approaches a detection or interrogation zone created by an EAS pedestal located at the exit of a store, the tag analog module 104 can “sense” the detection zone signals and then report this information to the processor module 102 for appropriate processing. In this embodiment, the processor module 102 can be a portion of any standard processing circuit board that can be inserted or integrated into a portable device for use with EAS systems and non-EAS systems.

Although the following discussion of the adaptive security device 100 is with reference to mobile EAS devices such as EAS tag deactivators, the invention applies equally to non-EAS devices, such as barcode scanners and RFID readers, or any other equipment that is used near or within an EAS detection zone and would cause false alarms.

FIG. 2 illustrates in more detail the tag disable electronic circuit 108 of FIG. 1. In this embodiment the tag disable electronic circuit 108 includes a current source 202 connected in parallel with a resistor 204 to form a voltage controlled current source for producing a sufficient current to alter a resonant frequency of an LC circuit 214 formed by inductor 210 and capacitor 212 such that the adaptive tag 100 does not set off an alarm when it is near or inside the detection zone created by an EAS unit. For example, the EAS system sends a radio frequency interrogation signal at a fundamental frequency of 58 kHz. In traditional EAS systems, the transmit signal energizes the adaptive security tag 100, which responds by emitting a single frequency signal at approximately the same frequency as the transmitter signal, i.e., 58 kHz,. However, if the frequency of the tag response signal is not equal to the frequency of the transmitter signal, the EAS system will not detect the adaptive security tag 100. By closing the switches 206, 208, the voltage controlled current source 202 can drive a DC current waveform, e.g., 300 milliamp turns (“mAT”), through the inductor 210 to modify the frequency of the tag response signal to be at frequency other than 58 kHz. In this example, using 300 mAT drive current results in a modification of the response frequency of at least 3 kHz, which is sufficient to “disable” the adaptive security tag 100 such that no alarm is generated by the EAS detection system. However, alternate drive current levels sufficient to shift the frequency of the tag response signal out of the range detectable by the EAS system will function equally as well.

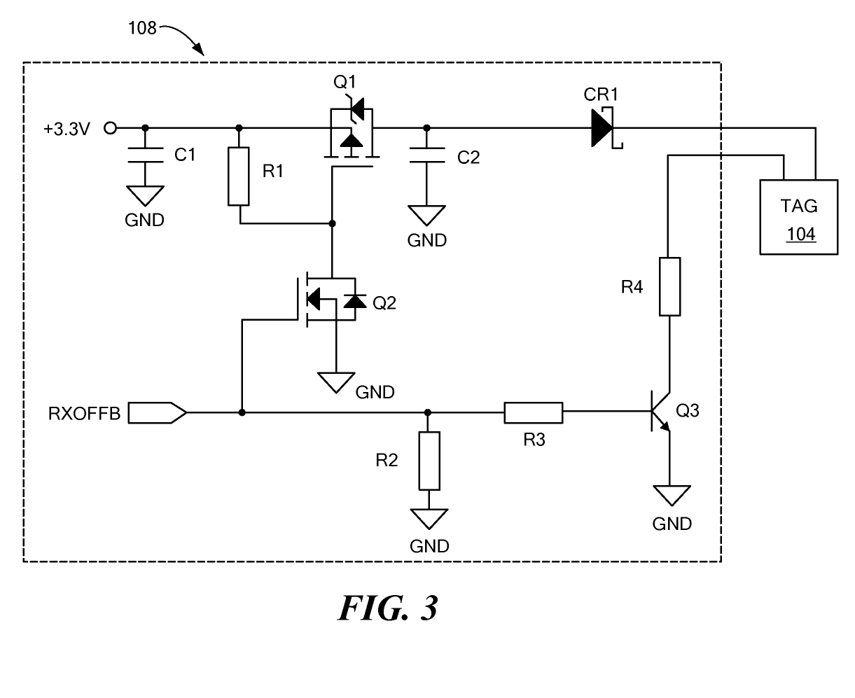

FIG. 3 illustrates another exemplary embodiment of the tag disable circuit 108 of FIG. 2. In this embodiment, two field effect transistors (“FET”) Q1 and Q2 function as a low side switch and a high side switch, respectively, to isolate the tag disable circuit 108 when not being driven. In this embodiment, the FETs Q1 and Q2 function as a two-pole switch similar to switches 206 and 208 (FIG. 2). In this example, Q1 and Q2 are complimentary pair transistors wherein Q1 is a p-channel MOSFET and Q2 is an n-channel MOSFET. The tag disable circuit 108 can further include a bipolar junction transistor (“BJT”) Q3, which provides an appropriate gate voltage to drive the FET Q2.

The tag disable circuit 108 can further include various resistors, e.g., R1, R2, R3 and R4, and various capacitors, e.g., C1, C2, to filter and condition the current signals and provide any necessary voltage drops for the operation of tag disable circuit 108. For example, R1 provides DC biasing for Q1, and R2, R3 and R4 provide DC biasing for Q3. C1 and C2 provide AC ground at the power source, i.e. +3.3V and at the positive side of the output signal. A tag disable control signal, e.g., RXOFFB, controls the “opening” and “closing” of the low side switch Q1 and a high side switch Q2 of the tag disable circuit 108.

The exemplary circuit of FIG. 3 operates based on the enabling of the tag disable control signal RXOFFB. In this example, the circuit is enabled when RXOFFB is held high, e.g., the voltage at RXOFFB=3.3.V. When RXOFFB is high, the gate-source voltage of Q2 is sufficient to activate Q2 and provide an electrical path between the source and the drain, thereby closing the “high-side” switch, i.e. Q2. The resultant voltage at the drain of Q2 provides a like voltage at the gate of Q1, which creates a sufficient gate-source voltage to activate Q1, thereby closing the “low-side” switch. Current to the tag module 104 is conducted through a diode CR1 which prevents current from leaking back into the tag disable circuit 108 form the tag module 104. Additionally, when RXOFFB is pulled high, the voltage at the base of Q3, created by the voltage dividing resistors R2 and R3, provides a base-emitter voltage sufficient to enable Q3, thus providing a return path for the current to drive the tag module 104.

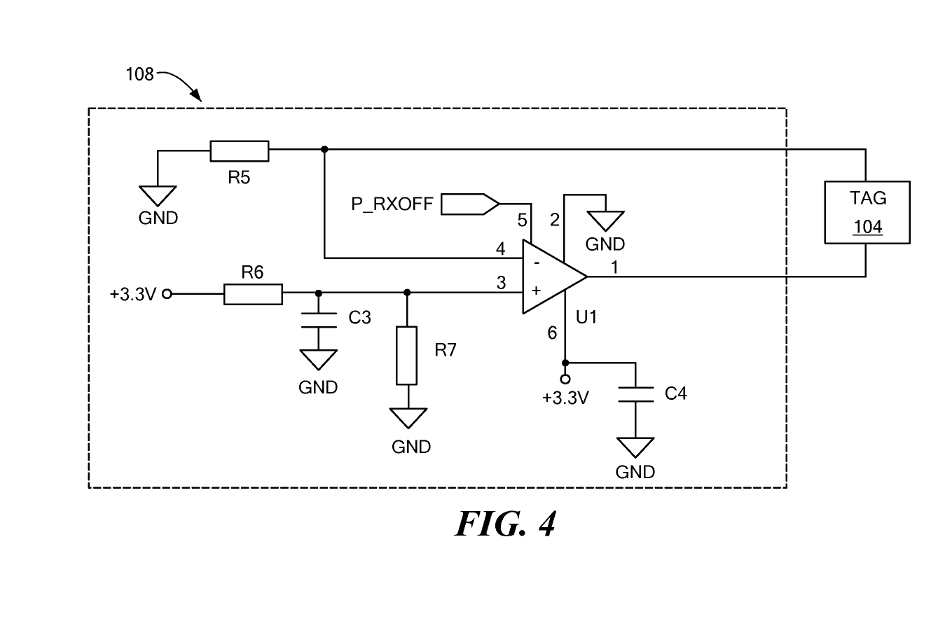

FIG. 4 illustrates another exemplary embodiment of the tag disable circuit 108 of FIG. 2. In this embodiment, the tag disable circuit 108 includes an operational amplifier (“op-amp”) U1, which provides the drive current to the analog tag module 104, connected to the tag disable circuit 108 to disable the adaptive tag 100 upon the appropriate tag disable command, e.g., P_RXOFF, from the controller 106. In this example, P_RXOFF is connected to a shutdown pin of the op-amp U1, and activates the op-amp U1 when pulled high, e.g., +3.3V. The tag disable circuit 108 can further include various resistors, e.g., R5, R6, R7, and various capacitors, e.g., C3, C4, to filter, condition and bias the current signals and provide any necessary voltage drops to the op-amp U1 for proper operation of tag disable circuit 108. For example, the resistor divider network formed by R6 and R7 set the input voltage at the positive input (pin 3) of the op-amp U1. Additionally, C3 and C4 provide adequate AC grounding for reliable operation of the op-amp U1.

The op-amp U1 operates using negative feedback from the analog tag module 104, connected to the negative input (pin 4). R5, in combination with the impedance of the analog tag module 104, determines the actual closed-loop gain of the op-amp U1. In this embodiment, the op-amp U1 can output a DC current waveform, e.g., 300 mAT, to drive the inductor 210 (FIG. 2) of the analog tag module 104 to modify the frequency of the tag response signal to be at a frequency other than transmitter signal frequency.

The present invention thus provides an adaptive security device 10 that includes a tag disable circuit 108 and, optionally, a sensor 110, such that an EAS tag 104 can be enabled and disabled at the appropriate time. For example, in one embodiment, the above can be achieved by wrapping small gauge wire (e.g., 30 AWG) around the longitudinal axis of an EAS tag 104 and running a current through the wire such that the product of number of turns and the current is greater than or equal to 300 milliamp turns. The bias on tag 104 can thus be changed with a voltage-controlled current source (see FIG. 2) and will not respond to a 58 kHz transmission from an EAS interrogation unit.

In an alternative embodiment, the small gauge wire may be wrapped around a supporting device, such as a bobbin, which may be fashioned such that each end of the wire terminates at a connector or at printed circuit board mounting posts for easy assembly. The bobbin may preferably be formed from a non-conductive material such as plastic.

In another alternative embodiment, an external bias strip or wire can be wound around a non-deactivatible tag body to permanently degauss the tag with a unipolarity pulse of sufficient magnitude, e.g., >100 gauss. The non-deactivatible tag could be reactivated by applying a bi-polar (AC) pulse of sufficient magnitude, e.g., >100 gauss.

In each embodiment, the adaptive security tag 100 is protected from power-loss by defaulting to the enabled state during a power loss. The present invention advantageously provides and defines an adaptive security device and system for protecting capital assets from theft that can operate in EAS detection zones without causing false alarm. The present invention further advantageously provides and defines a tag disable electronic circuit that disable the adaptive security device when a protect capital asset is used near or within an EAS detection zone.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An adaptive security device comprising:
a tag module; and
a processor module, the processor module having:
a tag disable electronic circuit; and
a controller, the controller providing at least one tag control command to the tag disable circuit, the tag disable electronic circuit operable to selectively enable and disable the tag module based on the at least one tag control command.

2. The adaptive security device of claim 1 wherein the tag module is an electronic article surveillance (“EAS”) tag module.

3. The adaptive security device of claim 2, the processor module further comprising a sensor coupled to the controller, the sensor operable to sense the presence of an EAS interrogation unit.

4. The adaptive security device of claim 2, wherein the EAS tag module is operable to:
receive an interrogation signal from an EAS interrogation unit, the interrogation signal having a first frequency;
generate a response signal, the response signal having a second frequency wherein the first frequency is substantially the same as the second frequency if the EAS tag is enabled; and
transmit the response signal to the EAS interrogation unit.

5. The adaptive security device of claim 2, wherein the EAS tag module is operable to:
receive an interrogation signal from an EAS interrogation unit, the interrogation signal having a first frequency;
generate a response signal, the response signal having a second frequency, wherein the first frequency is not substantially the same as the second frequency if the EAS tag is disabled; and
transmit the response signal to the EAS interrogation unit.

6. The adaptive security device of claim 2, wherein the tag disable electronic circuit comprises:
a voltage-controllable current source for producing a current sufficient to alter a resonant frequency generated by the EAS tag module such that the altered frequency is outside a frequency range detectable by the EAS interrogation unit.

7. The adaptive security device of claim 6, wherein the voltage-controllable current source includes a complimentary pair of transistors.

8. The adaptive security device of claim 6, wherein the voltage-controllable current source includes an operational amplifier.

9. The adaptive security device of claim 2, wherein the tag disable electronic circuit is operable to enable the EAS tag module upon loss of power.

10. The adaptive security device of claim 2, wherein the EAS tag module further includes a sensing element to sense the presence of an EAS interrogation unit.

11. The adaptive security device of claim 2, wherein the EAS tag module further includes
a longitudinal axis; and
a wire wrapped around the longitudinal axis of the EAS tag module, the wire arranged to carry a current sufficient to alter a resonant frequency generated by the EAS tag module such that the altered frequency is outside a frequency range detectable by the EAS interrogation unit.

12. The adaptive security device of claim 11, wherein a product produced by multiplying a number of turns of the wrapped wire by the current running through the wire is greater than or equal to 300 milliamp turns.

13. An adaptive EAS sensor for enabling/disabling an EAS tag, the sensor comprising:
a sensing element;
a tag disable electronic circuit; and
a controller adapted to receive signals from the sensing element, the controller providing at least one tag control command to the tag disable circuit based upon the received signals from the sensing element, the tag disable electronic circuit being operable to selectively enable and disable the EAS tag based on the at least one tag control command.

14. The adaptive EAS sensor of claim 13, wherein the sensing element is operable to sense the presence of an EAS interrogation unit.

15. The adaptive EAS sensor of claim 13, wherein the tag disable electronic circuit comprises a controllable current source, the controllable current source producing a current sufficient to alter a resonant frequency generated by the EAS tag such that the altered frequency is outside a frequency range detectable by an EAS interrogation unit.

16. The adaptive EAS sensor of claim 13, wherein the controller is operable to:
generate the tag control command operable to enable the EAS tag; and
instruct the tag disable electronic circuit to output a current sufficient to alter a resonant frequency generated by the EAS tag such that the altered frequency is outside a frequency range detectable by an EAS interrogation unit.

17. The adaptive EAS sensor of claim 13, wherein the controller is operable to:
generate the tag control command operable to disable the EAS tag; and
instruct the tag disable electronic circuit not to output a current, resulting in a resonant frequency generated by the EAS tag that is detectable by an EAS interrogation unit.

18. The adaptive EAS sensor of claim 13, wherein the tag disable electronic circuit is operable to enable the EAS tag upon loss of power.

19. A method for protecting assets from theft, the method comprising:
receiving at least one tag control command, the tag control command indicating the activation state of an adaptive security device; and
selectively enabling and disabling the adaptive security device based on the at least one tag control command.

20. The method of claim 19, further comprising:
receiving an EAS interrogation signal, the EAS interrogation signal having a first frequency;
generating a response signal, the response signal having a second frequency, wherein the first frequency is substantially the same as the second frequency if the EAS tag is enabled; and
transmitting the response signal.
